(19) United States
(12) Patent Application Publication
(10) Pub. No.: US 2020/0167504 A1
(43) Pub. Date: May 28, 2020

(54) APPARATUS AND METHOD FOR GENERATING SECRET INFORMATION

(71) Applicant: Electronics and Telecommunications Research Institute, Daejeon (KR)

(72) Inventors: Mi-Kyung OH, Daejeon (KR); Sang-Jae LEE, Daejeon (KR); You-Sung KANG, Daejeon (KR); Ik-Kyun KIM, Daejeon (KR); Ju-Han KIM, Daejeon (KR); Doo-Ho CHOI, Cheonan-si, Chungcheongnam-do (KR)

(73) Assignee: Electronics and Telecommunications Research Institute, Daejeon (KR)

(21) Appl. No.: 16/552,553

(22) Filed: Aug. 27, 2019

(30) Foreign Application Priority Data
Nov. 28, 2018 (KR) 10-2018-0149802

(51) Int. Cl. G06F 21/72; G06F 11/07; H04L 9/32; G09C 1/00

(52) U.S. Cl. CPC G06F 21/72; G06F 11/079; H04L 2209/12; G09C 1/00; H04L 9/3278

(57) ABSTRACT

Disclosed herein are an apparatus and method for generating secret information. The apparatus includes a data communication unit for receiving a request to output a content value and outputting the content value; and a microcontroller unit for generating a Physically Unclonable Function (PUF) response based on the content value, calculating the characteristic value of the PUF response, and generating secret information using the PUF response, the error of which is corrected using the characteristic value.

### CROSS REFERENCE TO RELATED APPLICATION

This application claims the benefit of Korean Patent Application No. 10-2018-0149802, filed Nov. 28, 2018, which is hereby incorporated by reference in its entirety into this application.

### BACKGROUND OF THE INVENTION

### 1. Technical Field

The present invention relates generally to IoT device security technology, and more particularly to technology for generating secret information based on the unique characteristics of an IoT device.

### 2. Description of the Related Art

Recently, with the growth of the Internet-of-Things (IoT) industry, including a smart grid, AMI, intelligent transportation services, real-time monitoring, and the like, it is expected that billions of cloud-connecting devices will be designed, produced and distributed in the next ten years. However, there is a lack of understanding of technology for IoT device security, and in spite of existing software-based security functions (e.g., storing a user ID/password, a master key for device authentication, and the like in memory), many attack cases, such as the theft of an ID/password or key using security vulnerabilities, have been reported. Accordingly, in the situation in which a huge number of IoT devices is implemented in practice, technology for generating secret information based on the unique characteristic of hardware, which enables an IoT device to autonomously create an ID/password for a user, to perform authentication, and to provide reliable operation, is required.

A Physically Unclonable Function (PUF) is used in order to create a unique and unclonable ID/password or master key for each device based on physical variation that naturally occurs when a semiconductor chip is manufactured. Early PUFs are generally implemented in FPGAs or ASICs by embodying the idea based on the characteristics of the components of a semiconductor chip, and the performance thereof is checked using the FPGA or ASIC. As representative examples of such PUFs, there are an Arbiter PUF, a Ring Oscillator (RO)-PUF, a VIA PUF, and the like. However, it is difficult to install an FPGA or ASIC in which a PUF is implemented in a resource-constrained environment such as an IoT device.

Recently, in order to solve the above problem, technology for deriving a PUF response directly from a commercial device has emerged. A representative method is a memory-based PUF response generation method using the physical characteristics of memory, such as SRAM, DRAM, or the like, which is installed in a device by default. An SRAM PUF uses the characteristic in which the binary state of the cells of SRAM acquired by powering up the SRAM is unique for each device. A DRAM PUF uses the characteristic in which, when a refresh function for maintaining information in DRAM cells is disabled, the discharge state of the cells over time is unique for each device. These techniques are advantageous in that they may provide the effects of compatibility and cost reduction by being immediately applied to existing devices because there is no need to produce a special semiconductor chip for a PUF.

However, these techniques are not always applicable. Because the SRAM PUF can be used only when SRAM is initially booted by being powered, it is not possible to acquire a PUF response in real time. The DRAM PUF is disadvantageous in that the process of acquiring a PUF response is time-consuming. Therefore, in addition to the existing technology, the demand for various techniques for generating unique secret information by acquiring a PUF response, which is the unique characteristic of the hardware of a device, directly from a commercial IoT device is increasing.

Meanwhile, Korean Patent Application Publication No. 10-2015-0051012, titled “Apparatus and method for generating encryption key of hardware using PUF” discloses an apparatus and method for generating the encryption key of hardware using PUF logic.

### SUMMARY OF THE INVENTION

An object of the present invention is to generate secret information by acquiring a PUF response from an external IoT device in real time.

Another object of the present invention to effectively generate an ID/password and a master key in an environment that is more diverse than the environment in which the conventional method is applicable.

In order to accomplish the above objects, an apparatus for generating secret information according to an embodiment of the present invention includes a data communication unit for receiving a request to output a content value and outputting the content value; and a microcontroller unit for generating a Physically Unclonable Function (PUF) response based on the content value, calculating the characteristic value of the PUF response, and generating secret information using the PUF response, the error of which is corrected using the characteristic value.

Here, the data communication unit may include a buffer for storing data transmitted to and received from an external device; and a register in which unique information for communicating with the external device is stored.

Here, the buffer may be configured with SRAM and output the binary state of the cells of the SRAM as the content value in response to a chip-enable signal received from the microcontroller unit.

Here, the microcontroller unit may generate the PUF response using the binary state of the cells of the SRAM, which is output from the buffer.

Here, the microcontroller unit may generate the PUF response using a value output from the register.

Here, the microcontroller unit may request the content value from the buffer by specifying the start address and size of the content value and acquire the content value from the buffer, thereby generating the PUF response.

Here, the microcontroller unit may request the content value of the register from the data communication unit and acquire the content value from the register, thereby generating the PUF response.

Here, the register may output a calibration value, which is used to calibrate the phases and amplitudes of an In-phase (I) channel and a Quadrature-phase (Q) channel for communicating with the external device, as the content value.

Here, the register may contain a unique characteristic value pertaining to a physical distance from the external device.

Here, the register may output a bitstream, which is output as a result of analog-to-digital conversion of an electromagnetic emission occurring in the data communication unit, as the content value.

Here, the microcontroller unit may calculate the steadiness value and the uniqueness value of the PUF response in order to calculate the characteristic value of the PUF response.

Here, the microcontroller unit may input a preset challenge value to a single external device two or more times through the data communication unit and calculate the degree of similarity between response values received from the single external device, thereby calculating the steadiness value.

Here, the microcontroller unit may input the preset challenge value to multiple external devices through the data communication unit and calculate a difference between response values received from the multiple external devices, thereby calculating the uniqueness value.

Here, the data communication unit may correct the error of the PUF response based on a result of calculation of the characteristic value of the PUF response.

Here, the data communication unit may further include an error correction unit for generating a codeword using an error correction code in order to correct the error of the PUF response based on the steadiness value and the uniqueness value of the PUF response.

Here, the error correction unit may generate the codeword using the PUF response and helper data, which the microcontroller unit generates based on the PUF response.

Also, in order to accomplish the above objects, a method for generating secret information, performed by an apparatus for generating the secret information, according to an embodiment of the present invention includes receiving, by a data communication unit, a request to output a content value from a microcontroller unit and outputting, by the data communication unit, the content value; generating, by the microcontroller unit, a Physically Unclonable Function (PUF) response based on the content value received from the data communication unit; calculating, by the microcontroller unit, the characteristic value of the PUF response; and generating, by the microcontroller unit, secret information using the PUF response, the error of which is corrected using the characteristic value.

Here, calculating the characteristic value of the PUF response may be configured such that the microcontroller unit calculates the steadiness value and the uniqueness value of the PUF response in order to calculate the characteristic value of the PUF response.

Here, calculating the characteristic value of the PUF response may be configured such that the microcontroller unit inputs a preset challenge value to a single external device two or more times through the data communication unit and calculates the degree of similarity between response values received from the single external device, thereby calculating the steadiness value.

Here, calculating the characteristic value of the PUF response may be configured such that the microcontroller unit inputs the preset challenge value to multiple external devices through the data communication unit and calculates a difference between response values received from the multiple external devices, thereby calculating the uniqueness value.

Here, calculating the characteristic value of the PUF response may be configured such that the data communication unit corrects the error of the PUF response based on a result of calculation of the characteristic value of the PUF response.

Here, calculating the characteristic value of the PUF response may be configured such that the data communication unit generates a codeword using an error correction code in order to correct the error of the PUF response based on the steadiness value and the uniqueness value of the PUF response.

Here, calculating the characteristic value of the PUF response may be configured such that the microcontroller unit generates helper data based on the PUF response and such that the data communication unit generates the codeword using the helper data and the PUF response.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows IoT devices connected with the Internet through an Access Point (AP) or a Data Collection Unit (DCU) according to an embodiment of the present invention;

FIG. 2 is a block diagram that shows an apparatus for generating secret information according to an embodiment of the present invention;

FIG. 3 is a view that shows an IoT device in which a data communication module is installed according to an embodiment of the present invention;

FIG. 4 is a block diagram that specifically shows an example of the data communication module illustrated in FIG. 3;

FIG. 5 is a flowchart that shows a method for generating secret information according to an embodiment of the present invention;

FIG. 6 is a view that shows the process of generating secret information using buffer content according to an embodiment of the present invention;

FIG. 7 is a view that shows the process of generating secret information using a calibration value according to an embodiment of the present invention;

FIG. 8 is a view that shows the process of generating secret information using register content according to an embodiment of the present invention;

FIG. 9 is a view that shows the process of generating secret information using a bitstream output from an Analog-to-Digital Converter (ADC) according to an embodiment of the present invention; and

FIG. 10 is a view that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising”, and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

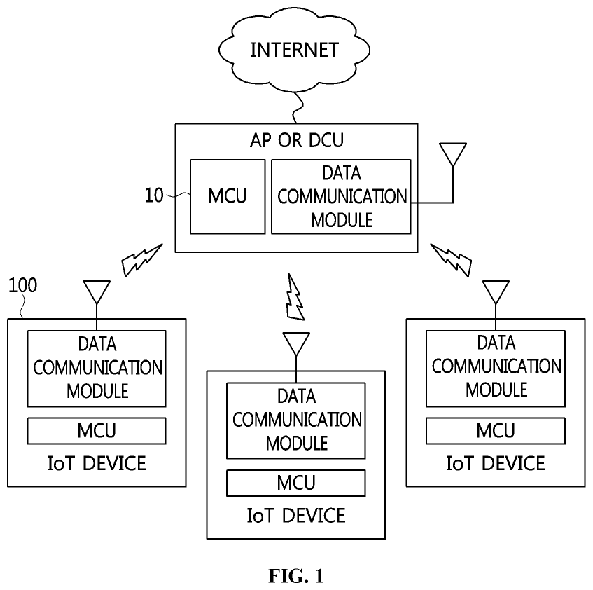

FIG. 1 is a view that shows IoT devices connected with the Internet via an AP or a DCU according to an embodiment of the present invention.

Referring to FIG. 1, a wireless IoT environment includes an Internet access device 10, such as an Access Point (AP) or a Data Collection Unit (DCU), and an IoT device 100.

The IoT device 100 may be directly connected with the Internet, or may be connected therewith via the Internet access device 10. For such direct or indirect connection with the Internet, the IoT device may include a data communication module and a Microcontroller unit (MCU), which is able to control data communication.

Any of various data communication interfaces, such as Wi-Fi, Bluetooth, Near-Field Communication (NFC), technology based on IEEE 802.15.4, Long Range (LoRa) technology, and the like, may be applied to the IoT device 100. Here, in consideration of the communication ranges, the data transmission rates, and the characteristics of power consumption of the respective data communication interfaces, a suitable data communication interface may be selected depending on the capabilities (power, memory, a CPU, and the like) of the IoT device 100, and may then be applied to the IoT device 100.

As described above, because most IoT devices 100 provide an Internet access function, there is a high probability that malicious code will be spread among the devices and frequent attacks on the devices. Particularly, there are security issues, such as the theft of IDs and passwords by an external attack in the process of authenticating users and devices, an external attack on a password that is not changed after being initially set in a device, and the like. Accordingly, the possibility of paralysis of infrastructure caused due to the halt and malfunctions of IoT devices, life-threatening cyberattacks, and the like is increased, but there is a limitation in the extent to which it is possible to apply existing IP security technology to lightweight/low-power devices.

In order to solve these problems, the apparatus and method for generating secret information according to an embodiment of the present invention may apply security technology to IoT devices by making use of a Physically Unclonable Function (PUF), which is used in order to create a physically secure and unclonable ID. The PUF is the unique and unclonable characteristic of each device based on physical variation that naturally occurs when a semiconductor chip is manufactured, and may serve as a digital fingerprint. The present invention proposes an apparatus and method for generating secret information, which acquire a PUF response in real time from a data communication module, which is necessarily installed in the IoT device 100.

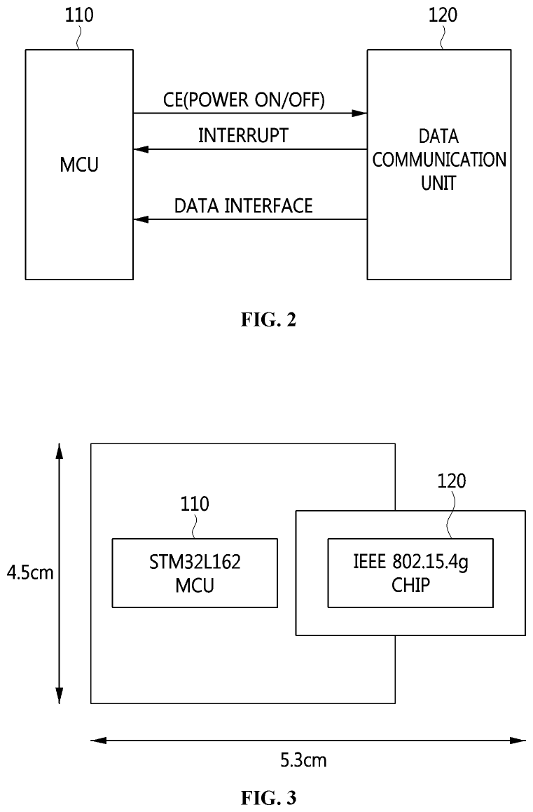

FIG. 2 is a block diagram that shows an apparatus for generating secret information according to an embodiment of the present invention.

Referring to FIG. 2, the apparatus for generating secret information according to an embodiment of the present invention includes a Microcontroller unit (MCU) 110 and a data communication unit 120.

Here, the apparatus for generating secret information according to an embodiment of the present invention may be an IoT device 100 configured such that the microcontroller unit 110 generates secret information by acquiring data from the data communication unit 120.

The microcontroller unit 110 may turn on or off the power of the data communication unit 120 using a chip-enable (CE) signal.

The data communication unit 120 may cause an interrupt when it has information that needs to be announced to the microcontroller unit 110, and may transmit data through a data interface.

The data interface may be a 4-wire Serial Peripheral Interface (SPI), which is currently widely used.

Here, the data communication unit 120 may include a buffer 121 for storing data transmitted to and received from an external device and a register 122 in which unique information for communicating with the external device is stored.

Here, the data communication unit 120 may output a content value by receiving a request to output the content value from the microcontroller unit 110.

Here, the microcontroller unit 110 may generate a PUF response based on the content value received from the data communication unit 120.

Here, the microcontroller unit 110 may calculate the characteristic value of the PUF response and generate secret information using the PUF response, the error of which is corrected using the characteristic value.

Here, the buffer 121 is configured with SRAM. The buffer 121 may output the binary state of the cells of the SRAM as the content value in response to the chip-enable signal received from the microcontroller unit.

Here, the buffer 121 may be the TX/RX buffer of the data communication module. The TX/RX buffer is a buffer that is used in order to send and receive data between devices, and may be storage for data transmission and reception.

Here, because the TX/RX buffer is configured with SRAM and because the binary state of the cells of the SRAM, acquired when the SRAM is powered, is unique for each device, the TX/RX buffer may be used as a PUF.

Here, because the microcontroller unit 110 is able to turn on or off the power of the data communication unit 120 anytime using a CE signal, the microcontroller unit 110 may generate a PUF response from the buffer of the data communication unit 120 in real time. Accordingly, the microcontroller unit 110 may overcome the disadvantage of the existing technology in which, when SRAM directly installed in an IoT device is used as a PUF, a PUF response cannot be obtained in real time because it is impossible to frequently turn on or off the power.

Here, the microcontroller unit 110 may generate a PUF response using the binary state of the cells of the SRAM, which is output from the buffer 121.

Here, the microcontroller unit 110 requests the content value from the buffer 121 by specifying the start address and the size of the content value and acquires the content value from the buffer 121, thereby generating a PUF response.

Here, the microcontroller unit 110 may turn off the power of the data communication unit 120 and then turn on the power again.

Here, the microcontroller unit 110 may request data from the data communication unit 120 by specifying the start address and size of the data in the buffer 121

Here, the data communication unit 120 may transmit buffer content, corresponding to the start address and the size, to the microcontroller unit 110 and the error correction unit 124.

Here, the microcontroller unit 110 may generate a PUF response using the buffer content.

Also, the content value may include a calibration value, which is used to calibrate the phases and amplitudes of the In-phase (I) channel and the Quadrature-phase (Q) channel on the reception path, the calibration value being stored in the register 122 of the data communication unit 120.

Here, the reception path of the data communication unit 120 may include the I channel and the Q channel.

Here, the difference between the phase of the I channel and that of the Q channel must be 90 degrees, and the amplitude of the I channel must be equal to that of the Q channel, but it is difficult to precisely maintain a phase difference of 90 degrees and identical amplitudes in practice due to variation occurring during a semiconductor manufacturing process. Accordingly, they may be calibrated using a unique calibration value.

That is, the calibration value may be a value for calibrating an I/Q mismatch, a DC offset, a frequency, an impedance, a filter bandwidth, or the like in order to calibrate the I channel and the Q channel.

Accordingly, the calibration value is unique for each IoT device, and a unique PUF response may be generated using the calibration value.

Here, when it receives a calibration instruction in the power-on state, the data communication unit 120 may store the calibration value in the register 122 as the content value as the result of performing calibration.

Here, the microcontroller unit 110 may provide the data communication unit 120 with the address of the register 122 at which the calibration value is stored.

Here, the data communication unit 120 may transmit the register content at the corresponding address to the microcontroller unit 110 and the error correction unit 124.

Here, the microcontroller unit 110 may generate a PUF response using the register content.

Also, the content value may include unique characteristic values, which are based on the physical distance from the external device and are stored in the data communication unit.

Here, the unique characteristic values may include an RSSI, an AGC value, a frequency offset, a clock offset, and the like provided by the data communication unit 120.

The apparatus for generating secret information may use the unique characteristic values only in an environment in which an AP or a DCU transmits a beacon and an IoT device receives the beacon.

In the case of IoT services, there are many environments in which an IoT device is stationary. Here, the distance from the AP to the IoT device is fixed. Accordingly, using this characteristic, the apparatus for generating secret information may extract the unique characteristic values of the IoT device.

First, the data communication unit 120 may measure the Received Signal Strength Indicator (RSSI) of a received packet. The RSSI varies depending on the distance from the AP, and respective IoT devices may have unique RSSIs when the distances from the AP differ from each other.

Also, the data communication unit 120 may include an Automatic Gain Control (AGC) function in order to receive a packet regardless of the distance from the AP.

Here, the AGC gain varies depending on the distance from the AP, and respective IoT devices may have unique AGC gain values when the distances from the AP differ from each other.

Because the AP and the IoT device use different clocks and use different frequency synthesizers in order to generate frequencies to be transmitted, a frequency offset and a clock offset may be necessarily generated. The frequency offset and the clock offset are unique for each IoT device, and these values may be used as unique characteristic values for a PUF.

The microcontroller unit 110 may turn on the power of the data communication unit 120, whereby the data communication unit 120 may operate so as to receive a packet.

Here, when it receives a packet (e.g., a beacon packet) from an AP or a DCU, the data communication unit 120 may notify the microcontroller unit 110 of the reception of the packet using an interrupt.

Here, the data communication unit 120 may store the unique characteristic values, such as an RSSI, AGC gain, a frequency offset, a clock offset, and the like, which are generated when it receives a packet, in the register 122.

Here, the microcontroller unit 110 may provide the data communication unit 120 with the address of the register 122 at which the unique characteristic values are stored.

Here, the data communication unit 120 may transmit the register content at the corresponding address to the microcontroller unit 110 and the error correction unit 124.

Here, the microcontroller unit 110 may generate a PUF response using the register content.

Also, the content value may include a bitstream that is output as the result of analog-to-digital conversion of an electromagnetic emission occurring in the data communication unit.

An analog-to-digital converter (ADC) 123 is a device for converting an analog signal to a digital signal, and most data communication modules may include an ADC in the reception path thereof.

Here, when the ADC 123 included in the data communication unit 120 is in an operating state because power is applied thereto, if a valid analog value is applied thereto, the ADC 123 may convert the analog value into a digital bitstream corresponding thereto and output the bitstream.

Here, the output bitstream is generated in such a way that the electromagnetic emission is sampled by the ADC 123 and output therefrom. That is, because the output bitstream is generated due to the unique characteristic of the device, it may be used as a PUF response.

Here, the microcontroller unit 110 may generate an electromagnetic emission corresponding to the operating frequency of the ADC 123 by repeatedly executing arbitrary code for generating the electromagnetic emission.

Here, the frequency of the electromagnetic emission may be unique for each IoT device depending on the clock used by the microcontroller unit 110, the characteristic of a board, and the like, and the output bitstream acquired by sampling the frequency of the electromagnetic emission may also be unique for each device. Therefore, the output bitstream may be used as a PUF response.

The microcontroller unit 110 may turn on the power of the data communication unit 120 and operate the ADC.

Here, the microcontroller unit 110 may repeatedly execute arbitrary code such that an electromagnetic emission is induced in the ADC 123. Here, even though IoT devices execute the same code (the same challenge value), the frequency of the generated electromagnetic emission may be different in the respective IoT devices depending on the clock used by the microcontroller unit 110 and the characteristics of a board.

Here, the data communication unit 120 may transmit the bitstream output from the ADC 123 to the microcontroller unit 110 and the error correction unit 124.

Here, the microcontroller unit 110 may generate a PUF response using the output bitstream stored in the register 122.

Also, the microcontroller unit 110 may calculate the steadiness value and the uniqueness value of the PUF response in order to calculate the characteristic value of the PUF response.

Here, the microcontroller unit 110 inputs a preset challenge value to a single external device two or more times through the data communication unit 120 and calculates the degree of similarity between the responses received from the single external device, thereby calculating the steadiness value.

Here, the microcontroller unit 110 may calculate the steadiness value using Equation (1).

Here, the steadiness value may represent the stability of the PUF response.

Here, the steadiness value is a measure for checking whether a constant value (a response value and a response bitstream) is output when a fixed challenge value (the specific address of the buffer according to an embodiment of the present invention) is repeatedly input to the buffer 121. The steadiness value is intra-chip variation (IC), and may be represented as shown in Equation (1):

$${IC}_{i} ( T , V ) = \frac{1}{N} {\sum }_{j = 1}^{N} \frac{HD ( {r}_{i , j} , {r}_{i , ref} )}{n} \times 100 \% \qquad ( 1 )$$

In Equation (1), IC is intra-chip variation and specifically denotes the i-th IC. Also, HD denotes a hamming distance, and r_{iref} denotes the mean of N responses output from the i-th device.

Here, as the IC is closer to 0, the PUF response has better stability, and the IC may be affected by temperature (T) and voltage (V).

Also, the microcontroller unit 110 inputs the preset challenge value to multiple external devices through the data communication unit 120 and calculates the difference between responses received from the multiple external devices, thereby calculating the uniqueness value.

Here, the microcontroller unit 110 may calculate the uniqueness value using Equation (2).

The uniqueness value may represent the uniqueness of the PUF response.

Here, the uniqueness may represent the uniqueness through which the multiple external devices (IoT devices) may be differentiated from each other.

Here, the uniqueness value means that response values and response bitstreams output from the multiple IoT devices in response to the same challenge value are different from each other and thus have high entropy. Here, the uniqueness value is extra-chip variation (EC), and may be represented as shown in Equation (2):

$$EC = \frac{1}{M ( M - 1 ) N} {\sum }_{i = 1}^{M} {\sum }_{k = 1 , k \neq i}^{M} {\sum }_{i = 1}^{N} \frac{HD ( {r}_{i , j} , {\overline{r}}_{k} )}{n} \times 100 \% \qquad ( 2 )$$

In Equation (2), EC is extra-chip variation and specifically denotes the i-th EC. Also, HD denotes a hamming distance, and r̅ₖ̅ denotes the mean of N responses output from the k-th device.

Here, as the EC is closer to 50%, the PUF response has higher uniqueness.

Table 1 shows the result of calculation of the characteristic value of the PUF response acquired from the buffer 121 of the data communication unit 120.

TABLE 1

| | IC (steadiness) | EC (uniqueness) |
|---|---|---|
| device #1 | 3.1% | 49.2% |
| device #2 | 2.8% | |
| device #3 | 2.6% | |
| device #4 | 2.1% | |

As shown in Table 1, the steadiness value and the uniqueness value of the PUF response acquired from the data communication unit 120 are close to 0% and 50%, respectively. Accordingly, it is confirmed that the PUF response has good performance.

However, as shown in the result of calculation of the steadiness value in Table 1, the response acquired from a single device is not constant, but ranges from 2 to 3%; that is, an error is present.

In order to use the PUF response for the purpose of security, for example, key generation or the like, the PUF response should contain no error. To this end, it is necessary to correct an error using an error correction code.

Here, the data communication unit 120 may correct the error of the PUF response based on the result of calculation of the characteristic value of the PUF response.

Here, the data communication unit 120 may further include the error correction unit 124, which generates a codeword using an error correction code in order to correct the error of the PUF response based on the steadiness value and the uniqueness value of the PUF response.

Here, the error correction unit 124 is implemented as hardware in the data communication unit 120. Accordingly, the error in the PUF response may be corrected in a hardware manner.

Here, the microcontroller unit 110 may generate helper data from the PUF response and transmit the same to the data communication unit 120.

Here, the error correction unit 124 may generate a codeword using the PUF response and the helper data, which the microcontroller unit 110 generates based on the PUF response.

Here, the microcontroller unit 110 may correct the error of the PUF response using the codeword received from the error correction unit 124.

Here, the microcontroller unit 110 may generate secret information using the PUF response, the error of which is corrected.

Here, the secret information may be an Id/password, a secret key, an encryption key, a master key, or the like.

Here, the error correction unit 124 may randomize the PUF response using an interleaver.

FIG. 3 is a view that shows an IoT device in which a data communication module is installed according to an embodiment of the present invention.

Referring to FIG. 3, the apparatus for generating secret information according to an embodiment of the present invention may be an IoT device including an STM32L162 MCU and a data communication module configured with an IEEE 802.15.4g chip.

Here, the STM32L162 MCU of the IoT device may be used as the microcontroller unit 110 of the apparatus for generating secret information, and the IEEE 802.15.4g chip of the IoT device may be used as the data communication unit 120 of the apparatus for generating secret information.

IEEE 802.15.4g SUN is known as a candidate for Low-Power Wide-Area (LPWA) communication technology, which is IoT access technology characterized by the construction of a separate network using an unlicensed spectrum. In Korea, IEEE 802.15.4g SUN is used for a trial service in the field of Advanced Metering Infrastructure (AMI) of the Korean Electric Power Corporation (KEPCO). Also, IEEE 802.15.4g SUN is wireless communication technology that may be used not only for AMI but also for various IoT services, such as systems for monitoring and managing underground utilities in the city, an intelligent transportation service, real-time monitoring, and the like.

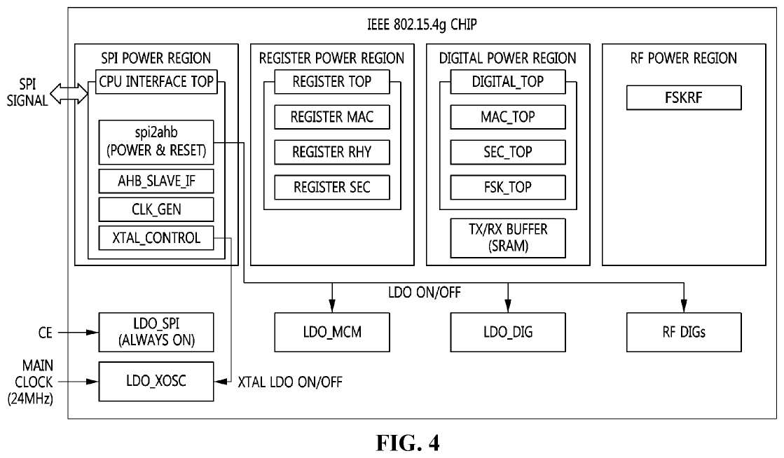

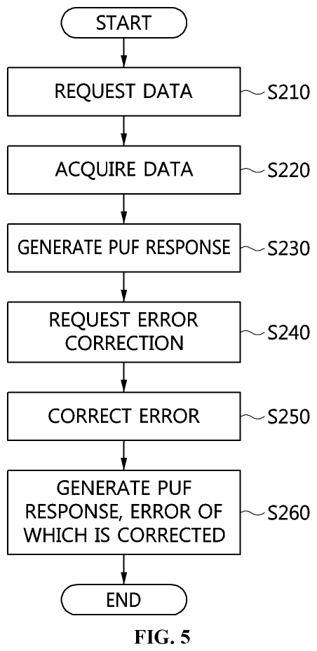

FIG. 4 is a block diagram that specifically shows an example of the data communication module illustrated in FIG. 3.

Referring to FIG. 4, the data communication module configured with the IEEE 802.15.4g chip may communicate with the MCU through a Serial Peripheral Interface (SPI), and the power of the data communication module may be completely turned off through a CE signal. Also, the IEEE 802.15.4g chip includes a TX/RX buffer, which is essentially included in the data communication module. Here, the TX/RX buffer may be configured with SRAM.

The TX/RX buffer is a buffer that is necessary in order to send and receive data between devices, and may correspond to storage for data transmission and reception. Because the TX/RX buffer is configured with SRAM and because the binary state of the cells of the SRAM, acquired when power is applied thereto, is unique in each device, it may be used as a PUF. Also, because the MCU is able to turn on or off the power of the data communication module anytime using a CE signal when necessary, a PUF response may be acquired from the buffer of the data communication module in real time. Accordingly, it becomes possible to overcome the disadvantage in which, when SRAM directly installed in an IoT device is used as a PUF, a PUF response cannot be obtained in real time because it is impossible to frequently turn on or off the power.

FIG. 5 is a flowchart that shows a method for generating secret information according to an embodiment of the present invention.

Referring to FIG. 5, in the method for generating secret information according to an embodiment of the present invention, first, data may be requested at step S210.

That is, at step S210, the microcontroller unit 110 may control the power on/off of the buffer 121 of the data communication unit 120 using a chip-enable signal, and may request data (a content value) using the address and size of the data.

Here, at step S210, the microcontroller unit 110 may request register content, corresponding to a calibration value or a unique characteristic value based on the physical distance from an external device, which is unique information stored in the register 122 of the data communication unit 120, or may request a bitstream that is output as the result of analog-to-digital conversion of an electromagnetic emission occurring in the data communication unit 120.

Also, in the method for generating secret information according to an embodiment of the present invention, the data may be acquired at step S220.

That is, at step S220, the data communication unit 120 may acquire data (a content value) at the corresponding address from the buffer 121 and provide the data to the microcontroller unit 110.

Here, the buffer 121, configured with SRAM, may output the binary state of the cells of the SRAM as the content value in response to a chip-enable signal received from the microcontroller unit 110.

Here, the buffer 121 may be the TX/RX buffer of the data communication module. The TX/RX buffer is a buffer that is used in order to send and receive data between devices, and may correspond to storage for data transmission and reception.

Here, because the TX/RX buffer is configured with SRAM and because the binary state of the cells of the SRAM, acquired when power is applied thereto, is unique in each device, the TX/RX buffer may be used as a PUF.

Here, because the microcontroller unit 110 is able to turn on or off the power of the data communication unit 120 anytime through a CE signal, a PUF response may be generated from the buffer of the data communication unit 120 in real time. Therefore, the microcontroller unit 110 may overcome the disadvantage of the conventional technology in which, when SRAM directly installed in an IoT device is used as a PUF, a PUF response cannot be obtained in real time because it is impossible to frequently turn on or off the power.

Here, at step S220, register content, corresponding to a calibration value or a unique characteristic value based on the physical distance from an external device, which is unique information stored in the register 122 of the data communication unit 120, may be output. Alternatively, a bitstream may be output from the analog-to-digital converter (ADC) 123 as the result of analog-to-digital conversion of an electromagnetic emission occurring in the data communication unit 120.

Also, in the method for generating secret information according to an embodiment of the present invention, a PUF response may be generated at step S230.

That is, at step S230, the microcontroller unit 110 may generate a PUF response using the binary state of the cells of the SRAM (buffer content), which is output from the buffer 121, the register content (the calibration value or the unique characteristic value based on the distance), or the bitstream output from the ADC.

Here, at step S230, the microcontroller unit 110 may generate a PUF response using the buffer content, the calibration value, the unique characteristic value based on the distance, or the bitstream output from the ADC, which is acquired from the data communication unit 120.

Also, in the method for generating secret information according to an embodiment of the present invention, error correction may be requested at step S240.

That is, at step S240, the microcontroller unit 110 may calculate the characteristic value of the PUF response and request the data communication unit 120 to correct the error of the PUF response based on the characteristic value.

Here, at step S240, the microcontroller unit 110 may calculate the steadiness value and the uniqueness value of the PUF response in order to calculate the characteristic value of the PUF response.

Here, at step S240, the microcontroller unit 110 inputs a preset challenge value to a single external device two or more times through the data communication unit 120 and calculates the degree of similarity between responses received from the single external device, thereby calculating the steadiness value.

Here, at step S240, the microcontroller unit 110 may calculate the steadiness value using Equation (1).

Here, the steadiness value may represent the stability of the PUF response.

Here, the steadiness value is a measure for checking whether a constant value (a response value and a response bitstream) is output when a fixed challenge value (the specific address of the buffer 121 according to an embodiment of the present invention) is repeatedly input to the buffer 121. The steadiness value is intra-chip variation (IC), and may be represented as shown in Equation (1).

In Equation (1), IC is intra-chip variation and specifically denotes the i-th IC. Also, HD denotes a hamming distance, and r_{i,ref} denotes the mean of N responses output from the i-th device.

Here, as the IC is closer to 0, the PUF response has better stability, and the IC may be affected by temperature (T) and voltage (V).

Here, at step S240, the microcontroller unit 110 inputs the preset challenge value to multiple external devices through the data communication unit 120 and calculates the difference between the responses received from the multiple external devices, thereby calculating the uniqueness value.

Here, at step S240, the microcontroller unit 110 may calculate the uniqueness value using Equation (2).

The uniqueness value may represent the uniqueness of the PUF response.

Here, the uniqueness value may represent the uniqueness through which the multiple external devices (IoT devices) may be differentiated from each other.

Here, the uniqueness value means that response values and response bitstreams output from the multiple IoT devices in response to the same challenge value are different from each other and thus have high entropy. Here, the uniqueness value is extra-chip variation (EC), and may be represented as shown in Equation (2).

In Equation (2), EC is extra-chip variation and specifically denotes the i-th EC. Also, HD denotes a hamming distance, and r̅ₖ̅ denotes the mean of N responses output from the k-th device.

Here, as the EC is closer to 50%, the PUF response has higher uniqueness.

Table 1 shows the result of calculation of the characteristic value of the PUF response acquired from the buffer 121 of the data communication unit 120.

As shown in Table 1, the steadiness value and the uniqueness value of the PUF response acquired from the data communication unit 120 are close to 0% and 50%, respectively. Accordingly, it is confirmed that the PUF response has good performance.

However, as shown in the result of calculation of the steadiness value in Table 1, the response value acquired from a single device is not constant, but ranges from 2 to 3%; that is, an error is present.

In order to use the PUF response for the purpose of security, for example, key generation or the like, the PUF response should contain no error. To this end, it is necessary to correct an error using an error correction code.

Here, at step S240, the microcontroller unit 110 may generate helper data from the PUF response and transmit the same to the data communication unit 120.

Also, in the method for generating secret information according to an embodiment of the present invention, an error may be corrected at step S250.

That is, at step S250, the data communication unit 120 may generate a codeword using the PUF response and the helper data received from the microcontroller unit 110.

Here, at step S250, the microcontroller unit 110 may correct the error in the PUF response using the codeword received from the data communication unit 120.

Also, in the method for generating secret information according to an embodiment of the present invention, the PUF response, the error of which is corrected, may be generated at step S260.

That is, at step S260, the microcontroller unit 110 may generate secret information using the PUF response, the error of which is corrected.

Here, the secret information may be an ID/password, a secret key, an encryption key, a master key, or the like.

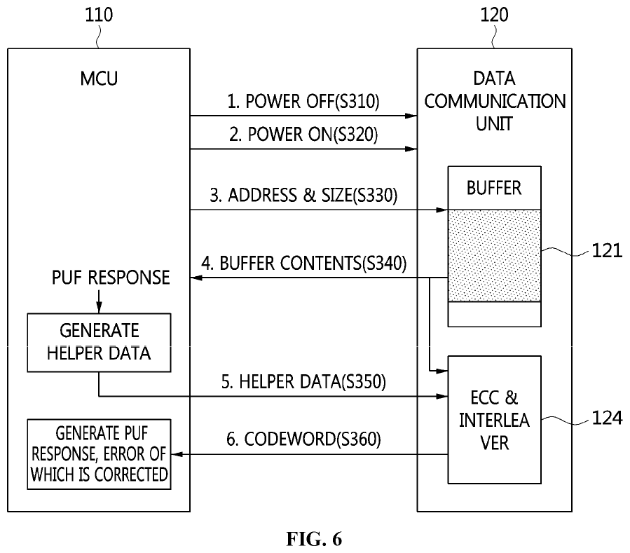

FIG. 6 is a view that shows the process of generating secret information using buffer content according to an embodiment of the present invention.

Referring to FIG. 6, it will be understood that the process of generating secret information using buffer content according to an embodiment of the present invention is illustrated.

Here, the microcontroller unit 110 may turn off the power of the data communication unit 120 at step S310, and may then turn on the power at step S320.

Here, the microcontroller unit 110 may request buffer content from the data communication unit 120 at step S330 by specifying the start address and the size of the buffer content in the buffer 121.

Here, the buffer content may be the binary state of the cells of SRAM, which is generated in response to a chip-enable signal received from the microcontroller unit 110.

Here, the data communication unit 120 may transmit the buffer content, corresponding to the start address and the size, to the microcontroller unit 110 and the error correction unit 124 for error correction at step S340.

Here, the microcontroller unit 110 may generate a PUF response using the buffer content and calculate the characteristic value of the PUF response at step S350.

Here, the microcontroller unit 110 may generate helper data for correcting the error in the PUF response based on the characteristic value of the PUF response.

Here, the microcontroller unit 110 may transmit the generated helper data to the data communication unit 120, thereby requesting error correction.

In order to use the PUF response for the purpose of security, such as key generation or the like, the PUF response should contain no error. To this end, it is necessary to correct an error using an error correction code.

Here, the data communication unit 120 may correct the error of the PUF response based on the result of calculation of the characteristic value of the PUF response at step S360.

Here, the data communication unit 120 may further include the error correction unit 124, which generates a codeword using an error correction code in order to correct the error of the PUF response based on the steadiness value and the uniqueness value of the PUF response.

Here, because the error correction unit 124 is implemented as hardware in the data communication unit 120, the error correction unit 124 may generate a codeword for correcting the error of the PUF response in a hardware manner.

Here, the error correction unit 124 may generate a codeword using the PUF response and the helper data, which the microcontroller unit 110 generates based on the PUF response.

Here, the microcontroller unit 110 may correct the error of the PUF response using the codeword received from the error correction unit 124.

Here, the microcontroller unit 110 may generate secret information using the PUF response, the error of which is corrected.

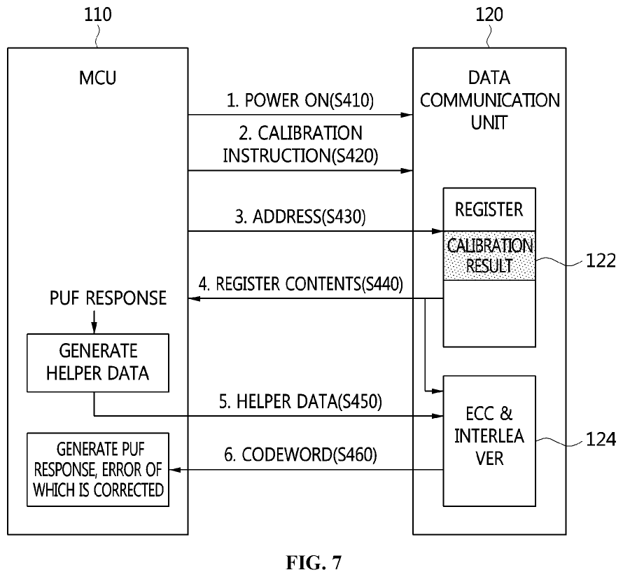

FIG. 7 is a view that shows the process of generating secret information using a calibration value according to an embodiment of the present invention.

Referring to FIG. 7, it will be understood that the process of generating secret information using a calibration value according to an embodiment of the present invention is illustrated.

Here, the microcontroller unit 110 may turn on the power of the data communication unit 120 at step S410 and instruct the data communication unit 120 to perform calibration at step S420.

Here, when it receives a calibration instruction in the power-on state, the data communication unit 120 may store a calibration value in the register 122 as the result of performing calibration.

The calibration value may be a value that is used to calibrate the phases and amplitudes of the I channel and the Q channel of a reception path.

Here, the reception path of the data communication unit 120 may include the I channel and the Q channel.

Here, the difference between the phase of the I channel and that of the Q channel must be 90 degrees, and the amplitude of the I channel must be equal to that of the Q channel, but it is difficult to precisely maintain a phase difference of 90 degrees and identical amplitudes in practice due to variation occurring during a semiconductor manufacturing process. Accordingly, they may be calibrated using the unique calibration value.

That is, the calibration value may be a value for calibrating an I/Q mismatch, a DC offset, a frequency, an impedance, a filter bandwidth, or the like in order to calibrate the I channel and the Q channel.

Accordingly, the calibration value is unique for each IoT device, and a unique PUF response may be generated using the calibration value.

Here, the microcontroller unit 110 may provide the data communication unit 120 with the address of the register 122, at which the calibration value is stored, at step S430.

Here, the data communication unit 120 may transmit the calibration value at the corresponding address, as the register content, to the microcontroller unit 110 and the error correction unit 124 for error correction at step S440.

Here, the microcontroller unit 110 may generate a PUF response using the register content and calculate the characteristic value of the PUF response at step S450.

Here, the microcontroller unit 110 may generate helper data for correcting the error in the PUF response based on the characteristic value of the PUF response.

Here, the microcontroller unit 110 may transmit the generated helper data to the data communication unit 120, thereby requesting error correction.

In order to use the PUF response for the purpose of security, such as key generation or the like, the PUF response should contain no error. To this end, it is necessary to correct an error using an error correction code.

Here, the data communication unit 120 may correct the error of the PUF response based on the result of calculation of the characteristic value of the PUF response at step S460.

Here, the data communication unit 120 may further include the error correction unit 124, which generates a codeword using an error correction code in order to correct the error of the PUF response based on the steadiness value and the uniqueness value of the PUF response.

Here, because the error correction unit 124 is implemented as hardware in the data communication unit 120, the error correction unit 124 may generate a codeword for correcting the error of the PUF response in a hardware manner.

Here, the error correction unit 124 may generate a codeword using the PUF response and the helper data, which the microcontroller unit 110 generates based on the PUF response.

Here, the microcontroller unit 110 may correct the error of the PUF response using the codeword received from the error correction unit 124.

Here, the microcontroller unit 110 may generate secret information using the PUF response, the error of which is corrected.

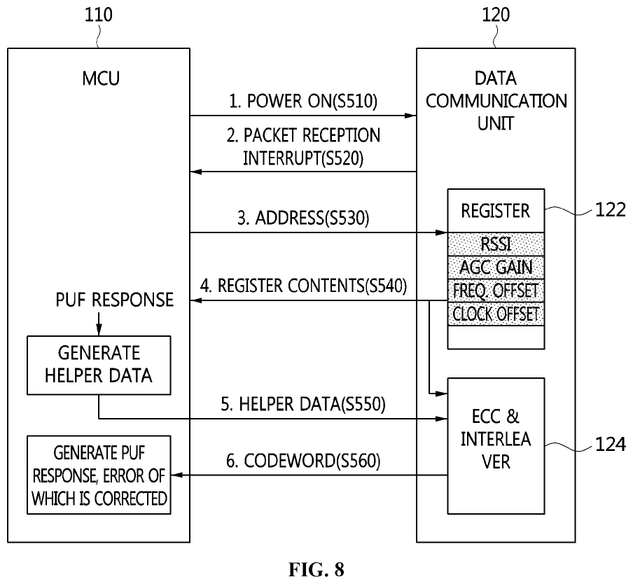

FIG. 8 is a view that shows the process of generating secret information using register content according to an embodiment of the present invention.

The microcontroller unit 110 may turn on the power of the data communication unit 120, whereby the data communication unit 120 may operate so as to receive a packet at step S510.

Here, when it receives a packet (e.g., a beacon packet) from an AP or a DCU, the data communication unit 120 may notify the microcontroller unit 110 of the reception of the packet using an interrupt at step S520.

Here, the data communication unit 120 may store unique characteristic values, such as an RSSI, AGC gain, a frequency offset, a clock offset, and the like, which are generated when it receives the packet, in the register 122.

The unique characteristic values may be information pertaining to the physical distance from an external device, which is stored in the data communication unit 120.

Here, the unique characteristic values may include the RSSI, the AGC value, the frequency offset, the clock offset, and the like provided by the data communication unit 120.

The apparatus for generating secret information may use the unique characteristic values only in an environment in which an AP or a DCU transmits a beacon and the IoT device receives the beacon.

In the case of IoT services, there are many environments in which an IoT device is stationary. Here, the distance between the AP and the IoT device is fixed. Accordingly, using this characteristic, the apparatus for generating secret information may extract the unique characteristic values of the IoT device.

The data communication unit 120 may measure the Received Signal Strength Indicator (RSSI) of the received packet. The RSSI varies depending on the distance from the AP, and respective IoT devices may have unique RSSIs when the distances from the AP differ from each other.

Also, the data communication unit 120 may include an Automatic Gain Control (AGC) function in order to receive a packet regardless of the distance from the AP.

Here, the AGC gain varies depending on the distance from the AP, and respective IoT devices may have unique AGC gain values when the distances from the AP differ from each other.

Because the AP and the IoT device use different clocks and use different frequency synthesizers in order to generate frequencies to be transmitted, a frequency offset and a clock offset may be necessarily generated. The frequency offset and the clock offset are unique for each IoT device, and these values may be used as unique characteristic values for a PUF.

Here, the microcontroller unit 110 may provide the data communication unit 120 with the address of the register 122, at which the unique characteristic values are stored, at step S530.

Here, the data communication unit 120 may transmit the unique characteristic values at the corresponding address, as the register content, to the microcontroller unit 110 and the error correction unit 124 for error correction at step S540.

Here, the microcontroller unit 110 may generate a PUF response using the register content and calculate the characteristic value of the PUF response at step S550.

Here, the microcontroller unit 110 may generate helper data for correcting the error in the PUF response based on the characteristic value of the PUF response.

Here, the microcontroller unit 110 may transmit the generated helper data to the data communication unit 120, thereby requesting error correction.

In order to use the PUF response for the purpose of security, such as key generation or the like, the PUF response should contain no error. To this end, it is necessary to correct the error using an error correction code.

Here, the data communication unit 120 may correct the error of the PUF response based on the result of calculation of the characteristic value of the PUF response at step S560.

Here, the data communication unit 120 may further include the error correction unit 124, which generates a codeword using an error correction code in order to correct the error of the PUF response based on the steadiness value and the uniqueness value of the PUF response.

Here, because the error correction unit 124 is implemented as hardware in the data communication unit 120, the error correction unit 124 may generate a codeword for correcting the error of the PUF response in a hardware manner.

Here, the error correction unit 124 may generate a codeword using the PUF response and the helper data, which the microcontroller unit 110 generates based on the PUF response.

Here, the microcontroller unit 110 may correct the error of the PUF response using the codeword received from the error correction unit 124.

Here, the microcontroller unit 110 may generate secret information using the PUF response, the error of which is corrected.

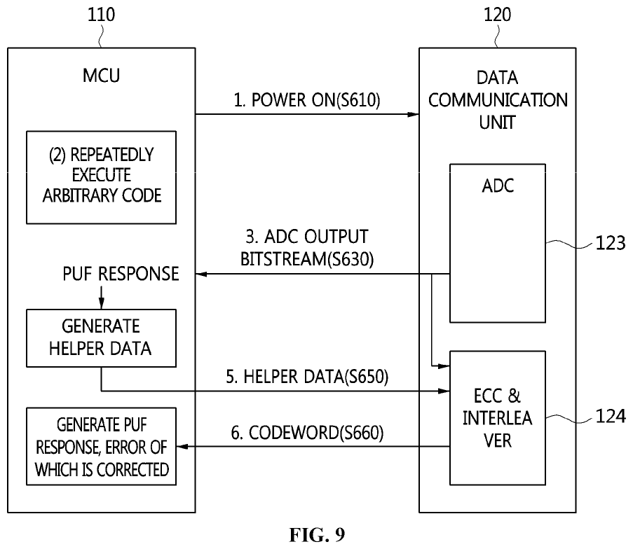

FIG. 9 is a view that shows the process of generating secret information using an ADC output bitstream according to an embodiment of the present invention.

Referring to FIG. 9, it will be understood that the process of generating secret information using an ADC output bitstream according to an embodiment of the present invention is illustrated.

Here, the microcontroller unit 110 may turn on the power of the data communication unit 120 at step S610 and operate an Analog-to-Digital Converter (ADC) 123.

Here, the microcontroller unit 110 may repeatedly execute arbitrary code for generating an electromagnetic emission.

Here, the microcontroller unit 110 repeatedly executes arbitrary code in order to generate an electromagnetic emission, thereby generating an electromagnetic emission corresponding to the operating frequency of the ADC 123.

The ADC 123 is a device for converting an analog signal into a digital signal, and most data communication modules may include an ADC in the reception path thereof.

Here, when the ADC 123 included in the data communication unit 120 is in an operating state because power is applied thereto, if a valid analog value is applied thereto, the ADC 123 may convert the analog value into a digital bitstream corresponding thereto and output the bitstream at step S630.

Here, the output bitstream may be generated in such a way that the electromagnetic emission is sampled by the ADC 123 and output therefrom. That is, because the output bitstream is generated due to the unique characteristic of the device, it may be used as a PUF response.

Here, the frequency of the electromagnetic emission may be unique for each IoT device depending on the clock used by the microcontroller unit 110, the characteristic of a board, and the like, and the output bitstream acquired by sampling the frequency of the electromagnetic emission may also be unique for each device. Therefore, the output bitstream may be used as a PUF response.

Here, the microcontroller unit 110 may repeatedly execute arbitrary code such that an electromagnetic emission is induced in the ADC 123. Here, even though IoT devices execute the same code (the same challenge value), the frequency of the generated electromagnetic emission may be different in the respective IoT devices depending on the clock used by the microcontroller unit 110 and the characteristics of a board.

Here, the data communication unit 120 may transmit the bitstream output from the ADC 123 to the microcontroller unit 110 and the error correction unit 124 at step S630.

Here, the microcontroller unit 110 may generate a PUF response using the output bitstream and calculate the characteristic value of the PUF response at step S650.

Here, the microcontroller unit 110 may generate helper data for correcting the error in the PUF response based on the characteristic value of the PUF response.

Here, the microcontroller unit 110 may transmit the generated helper data to the data communication unit 120, thereby requesting error correction.

In order to use the PUF response for the purpose of security, such as key generation or the like, the PUF response should contain no error. To this end, it is necessary to correct an error using an error correction code.

Here, the data communication unit 120 may correct the error of the PUF response based on the result of calculation of the characteristic value of the PUF response at step S660.

Here, the data communication unit 120 may further include the error correction unit 124, which generates a codeword using an error correction code in order to correct the error of the PUF response based on the steadiness value and the uniqueness value of the PUF response.

Here, because the error correction unit 124 is implemented as hardware in the data communication unit 120, the error correction unit 124 may generate a codeword for correcting the error of the PUF response in a hardware manner.

Here, the error correction unit 124 may generate a codeword using the PUF response and the helper data, which the microcontroller unit 110 generates based on the PUF response.

Here, the microcontroller unit 110 may correct the error of the PUF response using the codeword received from the error correction unit 124.

Here, the microcontroller unit 110 may generate secret information using the PUF response, the error of which is corrected.

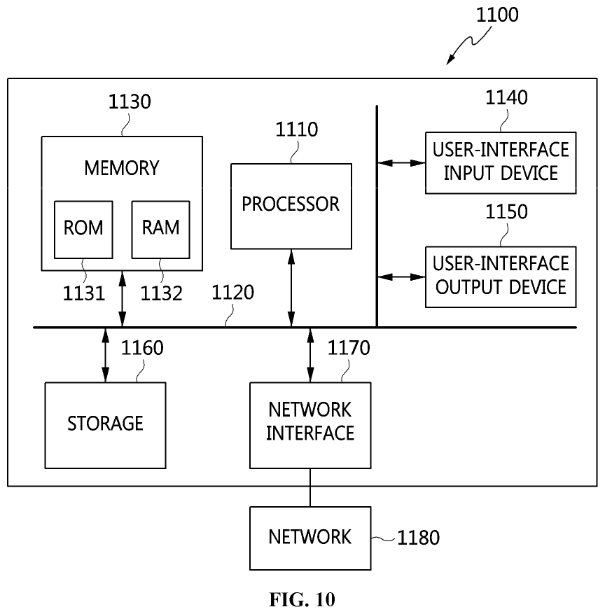

FIG. 10 is a view that shows a computer system according to an embodiment of the present invention.

Referring to FIG. 10, the apparatus for generating secret information according to an embodiment of the present invention may be implemented in a computer system 1100 including a computer-readable recording medium. As illustrated in FIG. 10, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected with a network 1180. The processor 1110 may be a central processing unit or a semiconductor device for executing processing instructions stored in the memory 1130 or the storage 1160. The memory 1130 and the storage 1160 may be various types of volatile or nonvolatile storage media. For example, the memory may include ROM 1131 or RAM 1132.

The present invention may generate secret information by acquiring a PUF response from an external IoT device in real time.

Also, the present invention may effectively generate an ID/password and a master key in an environment that is more diverse than the environment in which the conventional method is applicable.

As described above, the apparatus and method for generating secret information according to the present invention are not limitedly applied to the configurations and operations of the above-described embodiments, but all or some of the embodiments may be selectively combined and configured, so that the embodiments may be modified in various ways.

What is claimed is:

1. An apparatus for generating secret information, comprising:
a data communication unit for receiving a request to output a content value and outputting the content value; and
a microcontroller unit for generating a Physically Unclonable Function (PUF) response based on the content value, calculating a characteristic value of the PUF response, and generating secret information using the PUF response, an error of which is corrected using the characteristic value.

2. The apparatus of claim 1, wherein the data communication unit comprises:
a buffer for storing data transmitted to and received from an external device; and
a register in which unique information for communicating with the external device is stored.

3. The apparatus of claim 2, wherein the buffer is configured with SRAM and outputs a binary state of cells of the SRAM as the content value in response to a chip-enable signal received from the microcontroller unit.

4. The apparatus of claim 3, wherein the microcontroller unit generates the PUF response using the binary state of the cells of the SRAM, which is output from the buffer.

5. The apparatus of claim 2, wherein the register outputs a calibration value, which is used to calibrate phases and amplitudes of an In-phase (I) channel and a Quadrature-phase (Q) channel for communicating with the external device, as the content value.

6. The apparatus of claim 2, wherein the register outputs a unique characteristic value pertaining to a physical distance from the external device as the content value.

7. The apparatus of claim 2, wherein the data communication unit outputs a bitstream, which is output as a result of analog-to-digital conversion of an electromagnetic emission occurring in the data communication unit, as the content value.

8. The apparatus of claim 1, wherein the microcontroller unit calculates a steadiness value and a uniqueness value of the PUF response in order to calculate the characteristic value of the PUF response.

9. The apparatus of claim 8, wherein the microcontroller unit inputs a preset challenge value to a single external device two or more times through the data communication unit and calculates a degree of similarity between response values received from the single external device, thereby calculating the steadiness value.

10. The apparatus of claim 9, wherein the microcontroller unit inputs the preset challenge value to multiple external devices through the data communication unit and calculates a difference between response values received from the multiple external devices, thereby calculating the uniqueness value.

11. The apparatus of claim 8, wherein the data communication unit corrects the error of the PUF response based on a result of calculation of the characteristic value of the PUF response.

12. The apparatus of claim 11, wherein the data communication unit comprises:
an error correction unit for generating a codeword using an error correction code in order to correct the error of the PUF response based on the steadiness value and the uniqueness value of the PUF response.

13. The apparatus of claim 12, wherein the error correction unit generates the codeword using the PUF response and helper data, which the microcontroller unit generates based on the PUF response.

14. A method for generating secret information, performed by an apparatus for generating the secret information, comprising:
receiving, by a data communication unit, a request to output a content value from a microcontroller unit and outputting, by the data communication unit, the content value;
generating, by the microcontroller unit, a Physically Unclonable Function (PUF) response based on the content value received from the data communication unit;
calculating, by the microcontroller unit, a characteristic value of the PUF response; and
generating, by the microcontroller unit, secret information using the PUF response, an error of which is corrected using the characteristic value.

15. The method of claim 14, wherein calculating the characteristic value of the PUF response is configured such that the microcontroller unit calculates a steadiness value and a uniqueness value of the PUF response in order to calculate the characteristic value of the PUF response.

16. The method of claim 15, wherein calculating the characteristic value of the PUF response is configured such that the microcontroller unit inputs a preset challenge value to a single external device two or more times through the data communication unit and calculates a degree of similarity between response values received from the single external device, thereby calculating the steadiness value.

17. The method of claim 16, wherein calculating the characteristic value of the PUF response is configured such that the microcontroller unit inputs the preset challenge value to multiple external devices through the data communication unit and calculates a difference between response values received from the multiple external devices, thereby calculating the uniqueness value.

18. The method of claim 17, wherein calculating the characteristic value of the PUF response is configured such that the data communication unit corrects the error of the PUF response based on a result of calculation of the characteristic value of the PUF response.

19. The method of claim 18, wherein calculating the characteristic value of the PUF response is configured such that the data communication unit generates a codeword using an error correction code in order to correct the error of the PUF response based on the steadiness value and the uniqueness value of the PUF response.

20. The method of claim 19, wherein calculating the characteristic value of the PUF response is configured such that the microcontroller unit generates helper data based on the PUF response and such that the data communication unit generates the codeword using the helper data and the PUF response.
